(19) United States
(12) Patent Application Publication
(10) Pub. No.: US 2017/0271678 A1
(43) Pub. Date: Sep. 21, 2017

(54) Primer Surface Coating For High-Performance Silicon-Based Electrodes

(71) Applicant: GM Global Technology Operations LLC, Detroit, MI (US)

(72) Inventors: Li Yang, Troy, MI (US); Mei Cai, Bloomfield Hills, MI (US); Niccolo Jimenez, Royal Oak, MI (US); Fang Dai, Troy, MI (US); Qiangfeng Xiao, Troy, MI (US)

(21) Appl. No.: 15/070,677

(22) Filed: Mar. 15, 2016

(51) Int. Cl. H01M 4/62; H01M 4/38; H01M 4/134; H01M 10/0525; H01M 4/66

(52) U.S. Cl. CPC H01M 4/622; H01M 10/0525; H01M 4/661; H01M 4/662; H01M 4/625; H01M 4/134; H01M 4/386

(57) ABSTRACT

A negative electrode for an electrochemical cell (e.g., a lithium ion battery) is provided. The electrode has an active material that undergoes volumetric expansion during lithiation and delithiation, e.g., silicon-containing materials. The electrode has a current collector with an electrically conductive flexible surface primer coating disposed thereon. The primer coating comprises a polymer with a glass transition temperature of ≦85° C. and an electrically conductive particle. When assembled, the flexible surface primer coating serves to reduce strain at the interface between the active material and current collector. The primer coating and the electroactive material remain intact on the surface of the current collector after at least one cycle of lithium ion insertion and deinsertion in the electrode, thus minimizing or preventing charge capacity loss in the electrochemical cell. Methods for making such materials and using such coatings to minimize charge capacity fade in lithium ion electrochemical cells are likewise provided.

### FIELD

The present disclosure relates to high performance silicon-containing electrodes for electrochemical devices, where the silicon-containing electrodes are disposed on a current collector having a flexible primer surface coating to prevent volume expansion damage, capacity fade, and to enhance long-term performance. Methods for making such flexible primer surface coatings on silicon-containing electrodes, and methods for use thereof are also provided.

### BACKGROUND

This section provides background information related to the present disclosure which is not necessarily prior art.

High-energy density electrochemical cells, such as lithium ion batteries, can be used in a variety of consumer products and vehicles, such as Hybrid Electric Vehicles (HEVs) and Electric Vehicles (EVs). Typical lithium ion batteries comprise a first electrode (e.g., a cathode), a second electrode (e.g., an anode), an electrolyte material, and a separator. Often a stack of lithium ion battery cells are electrically connected to increase overall output. Conventional lithium ion batteries operate by reversibly passing lithium ions between the negative electrode and the positive electrode. A separator and an electrolyte are disposed between the negative and positive electrodes. The electrolyte is suitable for conducting lithium ions and may be in solid or liquid form. Lithium ions move from a cathode (positive electrode) to an anode (negative electrode) during charging of the battery, and in the opposite direction when discharging the battery.

Contact of the anode and cathode materials with the electrolyte can create an electrical potential between the electrodes. When electron current is generated in an external circuit between the electrodes, the potential is sustained by electrochemical reactions within the cells of the battery. Each of the negative and positive electrodes within a stack is connected to a current collector (typically a metal, such as nickel or copper for the anode and aluminum for the cathode). During battery usage, the current collectors associated with the two electrodes are connected by an external circuit that allows current generated by electrons to pass between the electrodes to compensate for transport of lithium ions.

By way of non-limiting example, cathode materials for lithium batteries typically comprise an electroactive material which can be intercalated with lithium ions, such as lithium-transition metal oxides or mixed oxides or lithium iron phosphates. The electrolyte typically contains one or more lithium salts, which may be dissolved and ionized in a non-aqueous solvent.

The negative electrode typically includes a lithium insertion material or an alloy host material. Typical electroactive materials for forming an anode include lithium-graphite intercalation/alloy compounds, lithium-silicon intercalation/alloy compounds, lithium-tin intercalation/alloy compounds, lithium alloys. While graphite compounds are most common, recently, anode materials with high specific capacity (in comparison with conventional graphite) are of growing interest. For example, silicon has the highest known theoretical charge capacity for lithium, making it a particularly promising material for rechargeable lithium ion batteries. Thus, silicon has a higher gravimetric and volumetric capacity, which provides higher energy densities than graphite, as shown by the capacities in Table 1 below.

TABLE 1

| | LiC₆ | Li_{4.4}Si | |
|---|---|---|---|
| | (graphite) | (silicon) | Li |
| Capacity/g | 340 mAh | 2,010 mAh | 3,860 mAh |
| Capacity/cm³ | 712 mAh | 2,400 mAh | 2,061 mAh |

However, current anode materials comprising silicon suffer from significant drawbacks. The large volume changes (e.g., volume expansion/contraction of greater than 300%) of silicon-containing materials during lithium insertion/extraction (e.g., intercalation/alloy and deintercalation/dealloy-intercalation/alloy) can result in physical damage to the anode, including wrinkling, fracture, or cracking. Such volumetric expansion thus can lead to loss of electrical contact and electrode activity. This is especially true at the loading density levels required for commercial viability of silicon-containing electrodes. Further, a solid electrolyte interface (SEI) layer formation can form on the active material surface and cause continuous electrolyte consumption and lithium ion loss, which can cause irreversible capacity fading in a lithium ion battery. The large volumetric expansion during intercalation/alloy of the anode comprising silicon can thus result in a decline of electrochemical cyclic performance, diminished Coulombic charge capacity (capacity fade), and extremely limited, poor cycle life.

It would be desirable to develop high performance negative electrode materials comprising silicon for use in high power lithium ion batteries, which overcome the current shortcomings that prevent their widespread commercial use, especially in vehicle applications. For long term and effective use, anode materials containing silicon should be capable of being included at high loading densities, while avoiding physical damage to provide minimal capacity fade and maximized charge capacity for long-term use in lithium ion batteries.

### SUMMARY

This section provides a general summary of the disclosure, and is not a comprehensive disclosure of its full scope or all of its features.

In various aspects, the present disclosure provides an electrode (e.g., a negative electrode) for an electrochemical cell. The electrode includes a current collector comprising a metal selected from the group consisting of: copper, copper alloys, stainless steel, and combinations thereof. A primer surface coating is formed on a surface of the current collector. The primer surface coating comprises a polymer having a glass transition temperature of less than or equal to about 85° C. and at least one type of electrically conductive particle. The electrode further includes an electroactive material that undergoes volumetric expansion during lithiation and delithiation (e.g., lithium ion intercalation/alloy and deintercalation/dealloyintercalation/alloy) disposed on the primer surface coating. In certain aspects, the electroactive material may comprise silicon. The primer surface coating and the electroactive material remain intact on the surface of the current collector after at least one cycle of lithiation and delithiation.

In other aspects, the present disclosure provides a lithium ion electrochemical cell comprising a negative electrode. The negative electrode comprises a current collector comprising a metal selected from the group consisting of: copper, copper alloys, stainless steel, and combinations thereof. The negative electrode also comprises a primer surface coating formed on a surface of the current collector comprising a polymer having a glass transition temperature of less than or equal to about 85° C. and an electrically conductive particle. The negative electrode further comprises an electroactive material layer comprising silicon disposed on the primer surface coating. The electrochemical cell further includes a positive electrode comprising a positive lithium-based electroactive material, a separator, and an electrolyte. The primer surface coating and the electroactive material remain intact on the surface of the current collector, so that the negative electrode has a capacity loss of less than or equal to about 25% after 25 cycles of lithiation and delithiation in the negative electrode of the lithium ion electrochemical cell.

In yet other aspects, the present disclosure provides a method of making a negative electrode for an electrochemical cell. The method comprises applying a primer surface coating comprising a polymer having a glass transition temperature of less than or equal to about 85° C. and an electrically conductive particle onto a surface of a current collector comprising a metal selected from the group consisting of: copper, copper alloys, stainless steel, and combinations thereof. The method also comprises applying an electroactive material layer comprising silicon on the primer surface coating to form the negative electrode, where the primer surface coating and the electroactive material remain intact on the surface of the current collector after at least one cycle of lithium ion lithiation and delithiation in the negative electrode.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an exemplary electrochemical battery for purposes of illustration.

FIG. 2 is a schematic of an exemplary electrode having a current collector and electroactive material layer before and after lithiation demonstrating strain that occurs due to volumetric changes in the electroactive material layer.

FIG. 3 is a negative electrode prepared in accordance with certain aspects of the present disclosure having a current collector, primer surface coating, and a negative electroactive material.

FIG. 4 shows specific discharge capacity over 100 discharge cycles in a cell for comparative testing of five samples, including a sample prepared in accordance with certain variations of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical compound, but which may also comprise additional substances or compounds, including impurities.

Example embodiments will now be described more fully with reference to the accompanying drawings.

The present technology pertains to improved electrochemical cells, especially lithium ion batteries, which may be used in vehicle applications. The lithium ion electrochemical cells may incorporate negative electrode (e.g., anode) materials that have a gravimetric energy density of greater than or equal to about 300 Wh/kg and a volumetric energy density of greater than or equal to about 700 Wh/L. In various aspects, the present disclosure provides an electrode, such as a negative electrode, for an electrochemical cell that comprises a current collector, a primer surface coating, and an electroactive material comprising silicon. The primer surface coating is disposed between the negative electrode current collector (typically copper) and the electrode active material comprising silicon to create a resilient interface between the current collector and electroactive material comprising silicon. The primer coating is electrically conductive and flexible, serving to effectively decrease interphase strain and providing improved flexibility and cycling performance for the silicon-containing electrode. In this manner, a high performance electrochemical cell is provided that has increased energy density and extended battery life that addresses the shortcomings conventionally associated with silicon-containing electrodes.

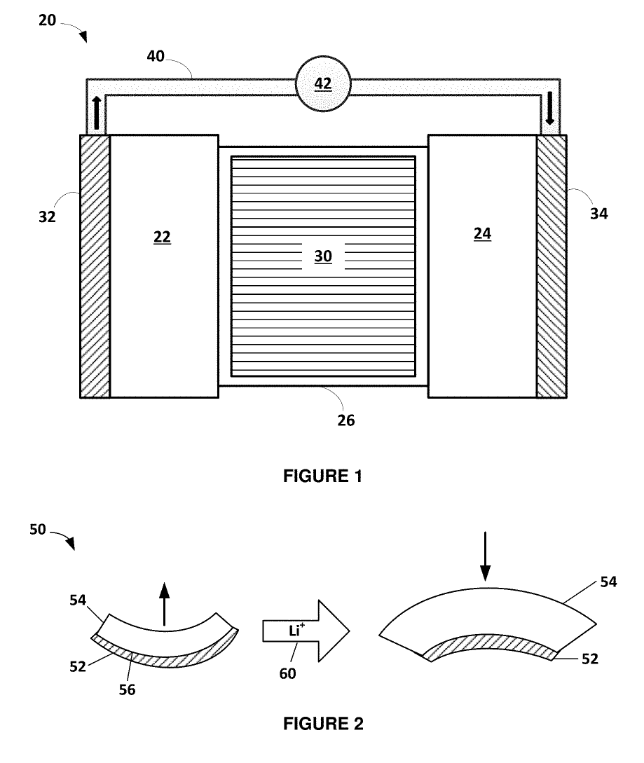

By way of background, an exemplary and schematic illustration of a lithium ion battery 20 is shown in FIG. 1. Lithium ion battery 20 includes a negative electrode 22, a positive electrode 24, and a separator 26 (e.g., a microporous polymeric separator) disposed between the two electrodes 22, 24. The negative electrode 22 may be referred to herein as an anode and the positive electrode 24 as a cathode. The separator 26 comprises an electrolyte 30, which may also be present in the negative electrode 22 and positive electrode 24. A negative electrode current collector 32 may be positioned at or near the negative electrode 22 and a positive electrode current collector 34 may be positioned at or near the positive electrode 24. The negative electrode current collector 32 and positive electrode current collector 34 respectively collect and move free electrons to and from an external circuit 40. An interruptible external circuit 40 and load 42 connects the negative electrode 22 (through its current collector 32) and the positive electrode 24 (through its current collector 34).

Each of the negative electrode 22, the positive electrode 24, and the separator 26 may further comprise the electrolyte 30 capable of conducting lithium ions. The separator 26 operates as both an electrical insulator and a mechanical support, by being sandwiched between the negative electrode 22 and the positive electrode 24 to prevent physical contact and thus, the occurrence of a short circuit. The separator 26, in addition to providing a physical barrier between the two electrodes 22, 24, can provide a minimal resistance path for internal passage of lithium ions (and related anions) for facilitating functioning of the lithium ion battery 20.

The lithium ion battery 20 can generate an electric current during discharge by way of reversible electrochemical reactions that occur when the external circuit 40 is closed (the negative electrode 22 is connected to the positive electrode 34) when the negative electrode 22 contains a relatively greater quantity of intercalated lithium. The chemical potential difference between the positive electrode 24 and the negative electrode 22 drives electrons produced by the oxidation of intercalated lithium at the negative electrode 22 through the external circuit 40 toward the positive electrode 24. Lithium ions, which are also produced at the negative electrode, are concurrently transferred through the electrolyte 30 and separator 26 towards the positive electrode 24. The electrons flow through the external circuit 40 and the lithium ions migrate across the separator 26 in the electrolyte 30 to form intercalated lithium at the positive electrode 24. The electric current passing through the external circuit 40 can be harnessed and directed through the load device 42 until the intercalated lithium in the negative electrode 22 is depleted and the capacity of the lithium ion battery 20 is diminished.

The lithium ion battery 20 can be charged or re-powered at any time by connecting an external power source to the lithium ion battery 20 to reverse the electrochemical reactions that occur during battery discharge. The connection of an external power source to the lithium ion battery 20 facilitates the otherwise non-spontaneous oxidation of intercalated lithium at the positive electrode 24 to produce electrons and lithium ions. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with intercalated lithium for consumption during the next battery discharge cycle. The external power source that may be used to charge the lithium ion battery 20 may vary depending on the size, construction, and particular end-use of the lithium ion battery 20. Some notable and exemplary external power sources include, but are not limited to, an AC wall outlet and a motor vehicle alternator. In many lithium ion battery configurations, each of the negative current collector 32, negative electrode 22, the separator 26, positive electrode 24, and positive current collector 34 are prepared as relatively thin layers (for example, several microns or a millimeter or less in thickness) and assembled in layers connected in electrical parallel arrangement to provide a suitable energy package.

Furthermore, the lithium ion battery 20 can include a variety of other components that while not depicted here are nonetheless known to those of skill in the art. For instance, the lithium ion battery 20 may include a casing, gaskets, terminal caps, and any other conventional components or materials that may be situated within the battery 20, including between or around the negative electrode 22, the positive electrode 24, and/or the separator 26, by way of non-limiting example. As noted above, the size and shape of the lithium ion battery 20 may vary depending on the particular application for which it is designed. Battery-powered vehicles and hand-held consumer electronic devices, for example, are two examples where the lithium ion battery 20 would most likely be designed to different size, capacity, and power-output specifications. The lithium ion battery 20 may also be connected in series or parallel with other similar lithium ion cells or batteries to produce a greater voltage output and power density if it is required by the load device 42.

Accordingly, the lithium ion battery 20 can generate electric current to a load device 42 that can be operatively connected to the external circuit 40. The load device 42 may be powered fully or partially by the electric current passing through the external circuit 40 when the lithium ion battery 20 is discharging. While the load device 42 may be any number of known electrically-powered devices, a few specific examples of power-consuming load devices include an electric motor for a hybrid vehicle or an all-electrical vehicle, a laptop computer, a tablet computer, a cellular phone, and cordless power tools or appliances, by way of non-limiting example. The load device 42 may also be a power-generating apparatus that charges the lithium ion battery 20 for purposes of storing energy.

Any appropriate electrolyte 30, whether in solid form or solution, capable of conducting lithium ions between the negative electrode 22 and the positive electrode 24 may be used in the lithium ion battery 20. In certain aspects, the electrolyte solution may be a non-aqueous liquid electrolyte solution that includes a lithium salt dissolved in an organic solvent or a mixture of organic solvents. Numerous conventional non-aqueous liquid electrolyte 30 solutions may be employed in the lithium ion battery 20. A non-limiting list of lithium salts that may be dissolved in an organic solvent to form the non-aqueous liquid electrolyte solution include LiPF₆, LiClO₄, LiAlCl₄, LiI, LiBr, LiSCN, LiBF₄, LiB(C₆H₅)₄, LiAsF₆, LiCF₃SO₃, LiN(CF₃SO₂)₂, and combinations thereof. These and other similar lithium salts may be dissolved in a variety of organic solvents, including but not limited to various alkyl carbonates, such as cyclic carbonates (ethylene carbonate (EC), propylene carbonate (PC), butylene carbonate(BC)), acyclic carbonates (dimethyl carbonate (DMC), diethyl carbonate (DEC), ethylmethylcarbonate (EMC)), aliphatic carboxylic esters (methyl formate, methyl acetate, methyl propionate), γ-lactones (γ-butyrolactone, γ-valerolactone), chain structure ethers (1,2-dimethoxyethane, 1-2-diethoxyethane, ethoxymethoxyethane), cyclic ethers (tetrahydrofuran, 2-methyltetrahydrofuran), and mixtures thereof.

The separator 30 may comprise, in one embodiment, a microporous polymeric separator comprising a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP.

When the separator 30 is a microporous polymeric separator, it may be a single layer or a multi-layer laminate, which may be fabricated from either a dry or wet process. For example, in one embodiment, a single layer of the polyolefin may form the entire microporous polymer separator 30. In other aspects, the separator 30 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 30. The microporous polymer separator 30 may also comprise other polymers in addition to the polyolefin such as, but not limited to, polyethylene terephthalate (PET), polyvinylidene fluoride (PVDF), and/or a polyamide. The polyolefin layer, and any other optional polymer layers, may further be included in the microporous polymer separator 30 as a fibrous layer to help provide the microporous polymer separator 30 with appropriate structural and porosity characteristics. Various conventionally available polymers and commercial products for forming the separator 30 are contemplated, as well as the many manufacturing methods that may be employed to produce such a microporous polymer separator 30.

The positive electrode 24 may be formed from a lithium-based active material that can sufficiently undergo lithium intercalation/alloy and deintercalation/dealloyintercalation/alloy while functioning as the positive terminal of the lithium ion battery 20. The positive electrode 24 may include a polymeric binder material to structurally fortify the lithium-based active material. One exemplary common class of known materials that can be used to form the positive electrode 24 is layered lithium transitional metal oxides. For example, in certain embodiments, the positive electrode 24 may comprise at least one spinel comprising a transition metal like lithium manganese oxide (Li₍ᵢ₊ₓ₎Mn₍₂₋ₓ₎O₄), where 0≦x≦1, where x is typically less than 0.15, including LiMn₂O₄, lithium manganese nickel oxide (LiMn₍₂₋ₓ₎NiₓO₄), where 0≦x≦1 (e.g., LiMn_{1.5}Ni_{0.5}O₄), lithium cobalt oxide (LiCoO₂), lithium manganese oxide (LiMn₂O₄), lithium nickel oxide (LiNiO₂), a lithium nickel manganese cobalt oxide (Li(NiₓMn_{y}Co_{z})O₂), where 0≦x≦1, 0≦y≦1, 0≦z≦1, and x+y+z=1, including LiMn_{0.33}Ni_{0.33}Co_{0.33}O₂, a lithium nickel cobalt metal oxide (LiNi_{(1-x-y)}CoₓM_{y}O₂), where 0<x<1, y<1, and M may be Al, Mn, or the like, other known lithium-transition metal oxides or mixed oxides lithium iron phosphates, or a lithium iron polyanion oxide such as lithium iron phosphate (LiFePO₄) or lithium iron fluorophosphate (Li₂FePO₄F). Such active materials may be intermingled with at least one polymeric binder, for example, by slurry casting active materials with such binders, like polyvinylidene fluoride (PVDF), ethylene propylene diene monomer (EPDM) rubber, or carboxymethoxyl cellulose (CMC). The positive current collector 34 may be formed from aluminum or any other appropriate electrically conductive material known to those of skill in the art.

In various aspects, the negative electrode 22 includes an electroactive material as a lithium host material capable of functioning as a negative terminal of a lithium ion battery. The negative electrode 22 may thus include the electroactive lithium host material and optionally another electrically conductive material, as well as one or more polymeric binder materials to structurally hold the lithium host material together. In accordance with various aspects of the present disclosure, the negative electrode 22 may include an active anode material comprising silicon. Thus, in certain variations, the anode active material may be in the form of particles comprising silicon that are intermingled with a material selected from the group consisting of: polyvinylidene difluoride (PVDF), a nitrile butadiene rubber (NBR), carboxymethoxyl cellulose (CMC), and combinations thereof, by way of non-limiting example, which form the negative electrode 22.

The negative electrode current collector 32 may be formed from a relatively ductile metal or metal alloy that is electrically conductive. Both nickel and copper are commonly used as materials for forming negative electrode current collectors 32. Ductility levels for select common metals used in current collectors are listed in Table 2 below.

TABLE 2

Theoretical Limit

| | Poisson's ratio | Physical Ductility |
|---|---|---|
| Element | (ν) | D |
| Absolute Limit, Perfect | ½ | 1 |
| Ductility | | |
| Gold (Au) | 0.44 | 0.93 |
| Lead (Pb) | 0.44 | 0.93 |
| Niobium (Nb) | 0.40 | 0.82 |
| Palladium (Pd) | 0.39 | 0.80 |
| Platinum (Pt) | 0.38 | 0.76 |
| Silver (Ag) | 0.37 | 0.73 |
| Vanadium (V) | 0.37 | 0.73 |
| Tin (Sn) | 0.36 | 0.69 |
| Aluminum (Al) | 0.35 | 0.65 |
| Copper (Cu) | 0.34 | 0.62 |
| Tantalum (Ta) | 0.34 | 0.62 |
| Titanium (Ti) | 0.32 | 0.54 |
| Nickel (Ni) | 0.31 | 0.50 |
| Iron (Fe) | 0.29 | 0.43 |
| Absolute Limit, Total | 0 | 0 |
| Brittleness | | |

Poisson's ratio (v), also known as the coefficient of expansion on a transverse axis, is the negative ratio of transverse to axial strain. When a material is compressed in one direction, the Poisson effect occurs when the material expands in the other two directions perpendicular to the direction of compression. Poisson's ratio v is a measure of this effect. The Poisson ratio is the fraction (or percent) of expansion divided by the fraction (or percent) of compression, for small values of these changes.

As can be seen, both aluminum and copper are more ductile than nickel. Nickel is often used as a current collector because it is much stronger than copper. However, nickel is also less ductile than copper. As will be discussed below, certain metals or metal alloys having relatively large ductility are particularly suitable for use as a current collector in combination with an electroactive material comprising silicon or tin. For example, current collectors may be formed of a metal comprising copper, iron, alloys or combinations thereof. The metal comprising iron may be a stainless steel alloy that has higher ductility levels than pure iron.

Notably, while some electrically conductive ductile metals may have sufficient ductility, they may not have sufficient reactivity with subsequently applied layers, such as the primer surface coating that is applied in accordance with the present teachings. This may include noble metals, like platinum, gold, and silver. For example, when silver or gold foil is used as a current collector, the electroactive material layer comprising silicon peels away from the foil, which is believed to be due to surface inertness. Ductile metals like silver, gold, and platinum may be further alloyed or treated to impart reactivity (e.g., by oxidation, etching, conversion coatings, CVD, or other chemical processes), but as noted above copper, copper alloys, and stainless steel are suitable for use as a negative electrode current collector 32 without necessarily requiring surface activation or treatment. It should be noted that other metals, such as aluminum, may have suitable ductility and reactivity levels to create a strong bond with subsequent layers, but are not typically used as negative electrode current collectors.

Anode active materials comprising silicon have the highest known theoretical charge capacity for lithium, which makes them quite desirable for use as negative electrodes in rechargeable lithium ion batteries. For example, Si-based electrodes have been considered for high-performance applications (EVs/HEVs) due to their high specific capacity and energy density materials. However, in practice, conventional anode materials comprising silicon suffer from significant drawbacks. Such silicon-containing materials show large volume changes (e.g., volume expansion/contraction) during lithium insertion/extraction (e.g., intercalation/alloy and deintercalation/dealloyintercalation/alloy) resulting in fracture or cracking of the anode, a decline of electrochemical cyclic performance and diminished Coulombic charge capacity (capacity fade), and extremely limited cycle life. In particular, capacity fading for silicon-based anodes has been challenging and a barrier to their widespread use in lithium ion batteries.

FIG. 2 shows a schematic illustrating a negative electrode 50 both prior to lithiation with lithium ions and after lithiation. The negative electrode 50 has a current collector 52 and an electroactive material layer 54 comprising silicon electroactive material disposed on a surface 56 of the current collector 52. The application of the electroactive material layer 54 comprising silicon electroactive material causes contraction or shrinkage of the electroactive material layer, thus bending the current collector 52 in a first direction (so that the current collector 52 initially has a concave shape). The amount of volumetric shrinkage depends on the material properties that is applied to the current collector 52. As noted above, the current collector 52 may be made of a metal that is relatively flexible or ductile in accordance with certain aspects of the present disclosure. For metals that have lower ductility, such as nickel, the electroactive material layer 54 comprising silicon electroactive material peels away from the current collector 52 as its volume changes during solidification on the current collector 52 prior to incorporation into an electrochemical cell and any exposure to lithium ions. More ductile metals, such as copper, copper alloys, or stainless steel alloys tend to exhibit sufficient electrical conductivity, flexibility during bending, and reactivity for use as the current collector 52 in accordance with the present technology.

After lithiation shown at arrow 60, lithium ions enter the electroactive material layer 54 and cause substantial volume expansion of the negative electrode 50. As noted above, the volumetric expansion of a silicon electroactive material can often be greater than 300% after lithiation. The volumetric expansion thus causes the current collector 52 to bend in an opposite second direction to the first direction (so that the current collector 52 now has a convex shape). This bending and volume expansion between the current collector 52 surface 56 and the electroactive material layer 54 results in an interface that suffers large strain, both before and after lithiation 60, ultimately leading to unacceptable loss of contact and conduction between the electroactive material layer 54 and the current collector 52 and wrinkling. As noted above, current collector materials having sufficient ductility and flexibility, like copper, are able to deform slightly to maintain the electronic contact between current collector and the electroactive material layer 54 comprising silicon electroactive material. However, even when a current collector 52 that has greater ductility is selected, at higher loading levels with greater amounts of electroactive material layer 54 (e.g., those used to meet performance requirements for commercially viable electrodes), the strain at the interface between the electroactive material layer 54 and the current collector 52 becomes too great resulting in physical separation and/or damage that causes a loss of capacity.

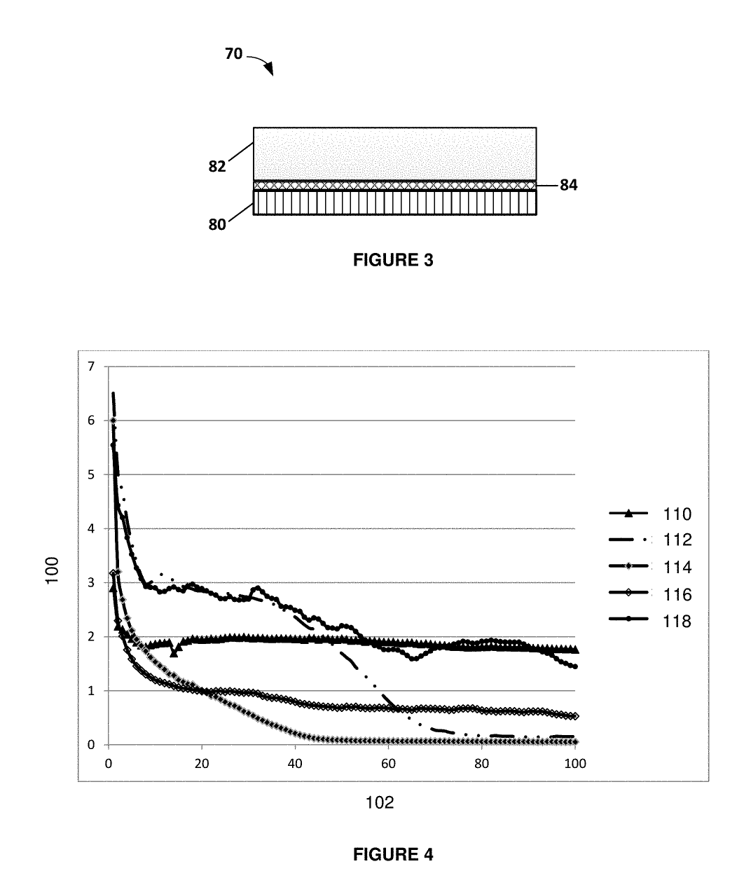

As shown in FIG. 3, in various aspects the present disclosure provides a negative electrode 70 that comprises a current collector 80 and an electroactive material layer 82. The electroactive material layer 82 may include at least one electroactive material, a conductive particle, and a binder, as described further below. A primer surface coating 84 is disposed on a surface of the current collector 80. The primer surface coating 84 may include at least one flexible polymer and at least one conductive particle, as will be described herein. The electroactive material layer 82 is disposed over the primer surface coating 84. The primer surface coating 84 is thus sandwiched between the current collector 80 and the electroactive material layer 82.

The current collector 80 may be formed of any of the ductile metals or metal alloys described above, such as copper, copper alloys, and iron alloys, such as stainless steel. The current collector 80 may be a solid thin foil layer, a grid, or a mesh layer. The current collector 80 desirably has a thickness of greater than or equal to about 10 μm.

The electroactive material layer 82 comprises one or more electroactive compounds that undesirably suffer from significant or substantial volumetric expansion and contraction (e.g., greater than 25% volume expansion or contraction) during intercalation/alloying and deintercalation/dealloying-intercalation/alloying of lithium ions. The electroactive material compounds may be solid particles. An electroactive material comprising silicon is such a composition. Such a material may be silicon (capable of intercalating lithium) or a silicon alloy. Exemplary materials include Si and SiOx. Silicon alloys include lithium-silicon and silicon containing binary and ternary alloys, such as SiSn, SiFe SiSnFe, SiSnAl, SiFeCo, and the like. In alternative variations, the present teachings may also be used in conjunction with other electroactive materials 82 that also exhibit significant and undesirable volumetric expansion/contraction during lithiation and delithiation, such as germanium, germanium oxide, tin, tin oxide, iron oxide, and iron oxide, alloys, and equivalents thereof. It should be noted that other electroactive materials may also be included in the electroactive material layer 82, such as graphite.

The conductive particle used in the electroactive material layer 82 may be carbon black, graphite, powdered nickel, metal particles, conductive polymers, or any combinations thereof. It should be noted that certain materials may fall under the category of electroactive materials or electrically conductive materials and that the categories themselves are not mutually exclusive. Electrically conductive particles are optional in the electroactive material layer 82, depending on the level of electrical conductivity in the electroactive materials.

Useful binders for the electroactive material layer 82 may include a polymeric material and an optional extractable plasticizer suitable for forming a bound porous composite, such as halogenated hydrocarbon polymers (such as poly(vinylidene chloride) and poly((dichloro-1,4-phenylene)ethylene), fluorinated urethanes, fluorinated epoxides, fluorinated acrylics, copolymers of halogenated hydrocarbon polymers, epoxides, ethylene propylene diamine termonomer (EPDM), ethylene propylene diamine termonomer (EPDM), polyvinylidene difluoride (PVDF), hex afluoropropylene (HFP), sodium-alginate, polyacrylic acid (PAA), carboxymethyl cellulose, aromatic polyimide (PI), ethylene acrylic acid copolymer (EAA), ethylene vinyl acetate copolymer (EVA), EAA/EVA copolymers, PVDF/HFP copolymers, and mixtures thereof.

In certain variations, the electroactive material layer 82 comprises greater than or equal to about 50% by weight to less than or equal to about 98% by weight, optionally greater than or equal to about 85% by weight to less than or equal to about 97% by weight of electroactive materials, including an electroactive material that experiences significant volume changes (e.g., silicon-containing particles, such Si, SiOx, Sn, SnOx, or their alloys, such as SiSn, SiFe, and the like) and optionally an additional electroactive material, such as the widely used anode material, graphite. Notably, graphite volume does not change significantly during lithiation and delithiation. Thus, in one embodiment, the electroactive material layer 82 may comprise a cumulative amount of electroactive materials at greater than or equal to about 85% to less than or equal to about 97% by weight where the electroactive materials comprise a silicon-containing electroactive material (or other negative electrode electroactive materials that undergo significant volumetric expansion during lithation and delithiation) and graphite. Of the electroactive materials, the silicon-containing electroactive material or other negative electroactive materials which experience significant volume changes may be greater than or equal to about 5% to less than or equal to about 50% by weight of the total electroactive materials in the electroactive material layer.

This combination of electroactive materials may be present in the negative electrode at greater than or equal to about 5 mg/cm² to less than or equal to about 50 mg/cm². In certain aspects, a silicon-containing electroactive material may be present in the negative electrode at greater than or equal to about 0.25 mg/cm² to less than or equal to about 25 mg/cm², optionally at greater than or equal to about 1 mg/cm² to less than or equal to about 20 mg/cm², and in certain aspects, optionally at greater than or equal to about 2 mg/cm² to less than or equal to about 15 mg/cm².

The electroactive material layer 82 may also comprise optionally greater than or equal to about 0.1% to less than or equal to about 10% by weight of an electrically conductive particle, and greater than or equal to about 0.1% to less than or equal to about 10% by weight binder.

In certain aspects, a combination of the electroactive compounds or materials (e.g., silicon-containing electroactive material and graphite) and electrically conductive material (e.g., carbon black) may be greater than or equal to about 51% by weight to less than or equal to about 99% by weight in the electroactive material layer. The combination of electroactive material and electrically conductive material is optionally present in the negative electrode at greater than or equal to about 5 mg/cm² to less than or equal to about 50 mg/cm².

An electroactive material layer 82 may be made by mixing the electrode active material, such as graphite and silicon-containing particles, into a slurry with a polymeric binder compound, a aqueous or non-aqueous solvent, optionally a plasticizer, and optionally if necessary, electrically conductive particles. In certain variations, the precursor to the electroactive material layer 82 may be formed by mixing greater than or equal to about 50% by weight to less than or equal to about 97% by weight of the electroactive material, greater than or equal to about 0.5% by weight to less than or equal to about 5% by weight of the electrically conductive material, greater than or equal to about 0.5% by weight to less than or equal to about 5% by weight of a binder, and greater than or equal to about 10% by weight to less than or equal to about 80% by weight of one or more solvents together. The slurry can be mixed or agitated, and then thinly applied to a substrate via a doctor blade. The substrate can be a removable substrate or alternatively a functional substrate that will be incorporated into the electrode of the battery.

In one variation, heat or radiation can be applied to evaporate the solvent from the electrode film, leaving a solid residue. The electrode film may be further consolidated, where heat and pressure are applied to the film to sinter and calendar it. In other variations, the film may be air-dried at moderate temperature to form self-supporting films. If the substrate is removable, then it is removed from the electrode film that is then further laminated to a surface of a current collector (in accordance with the present disclosure applied to a primer coating on the surface of the current collector). With either type of substrate, it may be necessary to extract or remove the remaining plasticizer prior to incorporation into the battery cell.

The electroactive material layer 82 as formed may have a conventional thickness, for example, greater than or equal to about 5 μm to less than or equal to about 200 μm.

The primer coating 84 comprises a polymer that is flexible and reduces stain at the interface between the electroactive material and the current collector, while retaining a strong bond between the materials during expansion and contraction of the electroactive material. A glass transition temperature (T_{g}) relates to the elasticity or flexibility of the polymer during operational conditions of the electrochemical cell. Thus, in certain variations, a polymer is selected that has a T_{g} of less than or equal to about 85° C. Suitable polymers include polyvinyl alcohol (PVA) having a T_{g} of 85° C., polyvinyl acetate (PVAc) having a T_{g} of 30° C., poly(vinylidene fluoride) (PVDF) having a T_{g} of −35° C., polyvinylpyrrolidone (PVP) having a T_{g} of 54° C., ethylene/propylene/diene copolymers (EPDM) having a T_{g} of −55° C., polyethylene oxide (PEO) having a T_{g} of −66° C., styrene/butadiene rubbers (SBR) having a T_{g} of −65° C. to −50° C., polysiloxane having a T_{g} of −127° C., and any combinations thereof. In certain aspects, the polymer comprises PVA, which does not shrink excessively when formed on the current collector and gives good elasticity/flexibility.

The primer coating 84 is also electrically conductive and thus also comprises an electrically conductive particle that may comprise carbon. Suitable carbon particles include graphite flakes, carbon or graphite fibers, carbon nanotubes, carbon black, graphene, and other forms of graphite, by way of non-limiting example. An average particle size of the electrically conductive particle may be greater than or equal to about 1 nm to less than or equal to about 50 μm.

In certain preferred aspects, the electrically conductive carbon particle comprises flakes of graphite that have an aspect ratio of greater than or equal to about 1 to less than or equal to about 1,000,000. Generally, an aspect ratio (AR) for particles is defined as AR=L/D, where L is the length of the longest axis and D is the diameter of the particle.

The primer surface coating 84 may have a thickness of greater than or equal to about 100 nm to less than or equal to about 10 μm, optionally greater than or equal to about 200 nm to less than or equal to about 5 μm, and in certain aspects optionally greater than or equal to about 300 nm to less than or equal to about 3 μm. In certain aspects, the primer surface coating 84 may have a specific electrical resistance of less than or equal to about 0.25 Ohm-cm and optionally less than or equal to about 0.1 Ohm-cm.

In certain variations, the primer surface coating 84 comprises greater than or equal to about 1% to less than or equal to about 50% by weight of a polymer and greater than or equal to about 5% to less than or equal to about 99% weight of electrically conductive particles comprising carbon and optionally comprises greater than or equal to about 5% to less than or equal to about 40% by weight of a polymer and greater than or equal to about 50% to less than or equal to about 95% weight of electrically conductive particles comprising carbon. In one variation, the primer surface coating 84 may comprise the polymer at about 30% by weight and the conductive particles at about 70% by weight (e.g., PVA at about 30% by weight and PVA at about 70% by weight graphite). The primer surface coating 84 may comprise other conventional additives and ingredients, as well.

The primer surface coating 84 may be applied via any conventional method of applying a polymeric composite precursor, such as slurry or solvent casting or other conventional techniques. For example, a slurry with a polymeric precursor, a solvent, one or more types of electrically conductive particles, and optionally a plasticizer is formed. The slurry can be mixed or agitated, and then thinly applied to a substrate, such as the current collector, via a doctor blade. The solvent can be removed from the primer coating films via volatilization and drying, leaving a solid residue. In certain variations, heat or radiation can be applied to volatilize and remove the solvent. After drying and removal of the solvent and optionally plasticizer, the surface primer coating 84 may be further cross-linked or cured via application of heat, actinic energy, or electron beam energy, as well known in the art.

A surface coating, including the primer surface coating 84 or the electroactive material layer 82 may include a single layer or a plurality of layers of distinct layers.

Certain commercial current collectors may have a surface coating applied to enhance electron conduction between the current collector surface and an eventual electroactive electrode layer applied thereto. These surface coatings may be composite materials having one or more electrically conductive particles and a polymer. However, these conventional coatings for electron conduction enhancement do not provide the flexibility/elasticity and therefore interface stress/strain reduction required for the successful use of electroactive materials having significant volumetric expansion during lithiation and delithiation, like silicon-containing active materials. Then, when conventional current collectors having such electron conduction enhancement coatings are used with silicon-containing electroactive electrodes, the electrode layer separates from the current collector and/or causes damage, resulting in a decline of electrochemical cyclic performance, diminished Coulombic charge capacity (capacity fade), and unacceptably short cycle life. However, in certain variations, a flexible primer coating 84 prepared in accordance with the present teachings may be applied over such an electron conduction enhancement coatings on a current collector and may enable successful use of electroactive materials having significant volumetric expansion during lithium cycling.

For example, a primer surface coating and an electroactive material remain intact on a surface of the current collector after at least 1 cycle of lithium ion insertion and deinsertion or lithiation and delithiation (which may include intercalation/alloying/alloying during lithiation and deintercalation/dealloying-intercalation/alloying/dealloying during delithiation) in the electrode, optionally at greater than or equal to 10 cycles of lithiation and delithiation, optionally at greater than or equal to 25 cycles of lithiation and delithiation, optionally at greater than or equal to 50 cycles of lithiation and delithiation, optionally at greater than or equal to 75 cycles of lithium ion lithiation and delithiation, optionally at greater than or equal to 100 cycles of lithium ion lithiation and delithiation, optionally at greater than or equal to 200 cycles of lithium ion lithiation and delithiation, optionally at greater than or equal to 500 cycles of lithium ion lithiation and delithiation, and optionally in certain variations, at greater than or equal to 1,000 cycles of lithiation and delithiation. As will be discussed further below, the primer surface coating and the electroactive material remaining intact on the current collector surface enables the electrode in the electrochemical cell to maintain sufficient charge capacity and electrochemical performance for long-term use, rather than suffering from capacity fade.

An electroactive material layer 82 may be made by mixing the electrode active material, such as silicon-containing powder or particles, into a slurry with a polymeric binder compound, a non-aqueous solvent, optionally a plasticizer, and optionally if necessary, electrically conductive particles. The slurry can be mixed or agitated, and then thinly applied to a substrate via a doctor blade. The substrate can be a removable substrate or alternatively a functional substrate, such as the current collector 82, attached to one side of the electrode film. In one variation, heat or radiation can be applied to evaporate the solvent from the electrode film, leaving a solid residue. The electrode film may be further consolidated, where heat and pressure are applied to the film to sinter and calendar it. In other variations, the film may be air-dried at moderate temperature to form self-supporting films. If the substrate is removable, then it is removed from the electrode film that is then further laminated to a current collector. With either type of substrate, it may be necessary to extract or remove the remaining plasticizer prior to incorporation into the battery cell.

Various embodiments of the inventive technology can be further understood by the specific examples contained herein. Specific Examples are provided for illustrative purposes of how to make and use the compositions, devices, and methods according to the present teachings and, unless explicitly stated otherwise, are not intended to be a representation that given embodiments of this invention have, or have not, been made or tested.

### Example A

In one example, a negative electrode is made in accordance with certain aspects of the present disclosure having a current collector in the form of a copper foil. The Cu foil is commercially available from Pre Materials and has a 20 μm thickness. A primer surface coating is disposed on the Cu foil. The primer surface coating comprises polyvinyl alcohol (PVA) and graphite flake particles. The PVA and carbon coating has 30% by weight PVA and 70% by weight graphite with thickness of 5 μm. All PVA and graphite is purchased from Sigma-Aldrich. The mixture PVA and graphite are dispersed in H₂O with solid content of 25% and slurry coated onto the Cu foil. Polyvinyl alcohol (PVA) has a glass transition temperature (T_{g}) of 85° C.

An electroactive material layer is then formed on the primer surface coating and current collector. The electroactive material layer includes 1.2 mg/cm² of silicon particles having an average particle size of 100 nm, 0.25 mg/cm² carbon black conductive particle having an average particle size of 200 nm to 2 μm, and 0.25 mg/cm² of a sodium alginate binder. All three are weighed and dispersed into H₂O and coated onto the primer coating on the Cu foil.

For comparison, a sodium alginate coating is instead formed on the copper foil current collector. Na-Alginate has a glass transition temperature of about 120° C. A precursor comprising Na-Alginate and water is applied to the copper foil. The Na-Alginate coating deforms the copper foil due to the strong volume shrinkage that occurs when molecules crystalize during drying. Furthermore, the film is also brittle and physically deforms the copper foil. The example of the primer coating prepared in accordance with certain aspects of the present disclosure that comprises PVA creates a superior film having greater elasticity.

### Example B

Several negative electrodes are tested in coin cells having Li metal as the counter electrode. CELGARD® monolayer polypropylene separators are soaked in the electrolyte solution, which includes 1M LiPF₆ dissolved in dimethyl carbonate-fluoroethylene carbonate (4:1 in volume, BASH®). The prepared electrodes are tested using a MACCOR® battery cycler system.

A first comparative example 110 has a copper current collector like that described above and an electroactive material comprising silicon particles as described above applied directly to the copper current collector at a 1.2 mg/cm² loading density.

A second comparative example 112 has a copper current collector with an electroactive material comprising silicon particles directly to the copper current collector at a 2.5 mg/cm² loading density.

A third comparative example 114 has a nickel foil current collector and an electroactive material comprising silicon particles as described above applied directly to the copper current collector at a 2.5 mg/cm² loading density.

A fourth comparative example 116 has a nickel current collector like that in the third comparative example 114 with an electroactive material comprising silicon particles directly to the copper current collector at a 1.2 mg/cm² loading density.

A fifth example 118 prepared in accordance with certain aspects of the present disclosure includes has a copper current collector with a primer surface coating comprising polyvinyl alcohol and graphite particles. The PVA and carbon primer coating is 30% PVA and 70% graphite with a thickness of about 5 μm, formed as described above in Example A. An electroactive material comprising silicon particles like those described above is applied on the surface primer coating over the copper current collector at a 2.5 mg/cm² loading density.

FIG. 4 shows charge capacity over 100 cycles. In FIG. 4, y-axis capacity (100) is in mAh units, while cycle number is shown on the x-axis (102). After 100 cycles, capacity fading is significant for the second comparative example 112, third comparative example 114, and fourth comparative example 116. The first example 110 and the fifth example 118 both retain a significant charge capacity. However, the fifth example has over double the amount of silicon active material. Both low and high loading silicon active material on a nickel current collector (third comparative example 114 and fourth comparative example 116) show poor cycling performance, which results from the poor interphase between the silicon/nickel. Nickel is much stronger than copper, but far capable of elongation and deformation, so that the silicon active material separates from the nickel current collector. Low silicon loading on the copper current collector (first comparative example 110) has a much more stable performance, than the high loading silicon loading on the copper current collector (second comparative example 112), due to less strain between the silicon/copper interface. Copper provides a greater ability to deform with greater ductility, but higher loading of silicon containing active materials desirable for commercial viability is not possible with copper alone. With a layer of PVA-carbon composite primer disposed between silicon/copper in the fifth example 118, good capacity retention is achieved with far greater loading densities. Thus, an electrochemical cell having increased energy density is provided with a high capacity silicon anode, providing extended battery life.

In various aspects, the inventive technology pertains to providing high performance, low capacity loss negative electrode materials comprising silicon. For example, the present disclosure contemplates a negative electrode comprising a current collector with a ductile metal. Such a metal may be selected from the group consisting of: copper, copper alloys, stainless steel, and combinations thereof. The negative electrode also includes a primer surface coating formed on a surface of the current collector comprising a polymer having a glass transition temperature of less than or equal to about 85° C. and an electrically conductive particle, such a graphite. Finally, an electroactive material comprising silicon is disposed on the primer surface coating. The primer surface coating and the electroactive material remain intact on the surface of the current collector after at least one cycle of lithiation and delithiation (lithium ion intercalation/alloying and deintercalation/dealloying-intercalation/alloying) when the electrode is incorporated into a lithium ion electrochemical cell. Such negative electrode assemblies can help accommodate the large volume changes that silicon undergoes during lithium cycling in a lithium ion battery and therefore minimize or prevent cracking of silicon and formation of an SEI layer on the surfaces of negative electrode materials (like silicon).

In accordance with the present teachings, flexible primer surface coating in combination with select current collectors in such an electrode assembly is an efficient way to resolve the problem of structural stress/strain in a silicon containing anode material during Li-ion insertion/extraction, by incorporating an elastic material into the system that helps reduce mechanical stress, cracking, and/or fracture between the active material and current collector during lithium migration. As noted above, the primer surface coating and the electroactive material remain intact on the surface of the current collector in accordance with the present teaching after at least one cycle of lithiation and delithiation (lithium ion intercalation/alloying and deintercalation/dealloying-intercalation/alloying) in the electrode and in certain aspects, after multiple cycles. Accordingly, silicon-based negative electrodes prepared in accordance with the principles of the present disclosure desirably have less than or equal to about 40% charge capacity decay (after the cycle stabilizes) or less than or equal to about 40% capacity loss after 25 cycles of lithiation and delithiation in the negative electrode of the lithium ion electrochemical cell, optionally less than or equal to about 35% capacity loss, optionally less than or equal to about 30% capacity loss, optionally less than or equal to about 25% capacity loss, optionally less than or equal to about 20% capacity loss, optionally less than or equal to about 15% capacity loss and in certain high performing silicon-based anodes, capacity loss is less than or equal to about 10% after 25 cycles of lithium ion intercalation/alloy and deintercalation/dealloy-intercalation/alloy. For example, a negative electrode comprising a silicon material with a primer surface coating can retain greater than about 60% of charge capacity, for example, having greater than or equal to about 60% capacity retention after 25 cycles of lithium ion insertion and deinsertion (intercalation/alloying and deintercalation/dealloying-intercalation/alloying) in an lithium ion electrochemical cell.

A battery may thus be assembled in a laminated cell structure, comprising an anode layer, a cathode layer, and electrolyte/separator between the anode and cathode layers. The anode and cathode layers each comprise a current collector. A negative anode current collector may be a copper collector foil, which may be in the form of an open mesh grid or a thin film. The current collector can be connected to an external current collector tab.

For example, in certain variations, an electrode membrane comprises the electrode active material (e.g., silicon) dispersed in a polymeric binder matrix over a primer surface coating on a current collector. The separator can then be positioned over the negative electrode element, which is covered with a positive electrode membrane comprising a composition of a finely divided lithium insertion compound in a polymeric binder matrix. A positive current collector, such as aluminum collector foil or grid completes the assembly. Tabs of the current collector elements form respective terminals for the battery. A protective bagging material covers the cell and prevents infiltration of air and moisture. Into this bag, an electrolyte is injected into the separator (and may also be imbibed into the positive and/or negative electrodes) suitable for lithium ion transport. In certain aspects, the laminated battery is further hermetically sealed prior to use.

Thus, in certain variations, the present disclosure provides an electroactive material, which may be used in an electrochemical cell, such as a lithium ion battery. A negative electrode material may comprise silicon or be a silicon alloy, for example. The negative current collector has a surface primer coating formed thereon, which is electrically conductive, comprises a polymer with a glass transition temperature of less than or equal to about 85° C. and electrically conductive particles. The primer surface coating is flexible and reduces the strain at the interface between the current collector and the negative electrode material. The primer surface coating and the electroactive material remain thus intact on the surface of the current collector after at least one cycle of and reduce strain and damage to the negative electrode during volume expansion.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode for an electrochemical cell comprising:
a current collector comprising a metal selected from the group consisting of: copper, copper alloys, stainless steel, and combinations thereof;
a primer surface coating formed on a surface of the current collector comprising a polymer having a glass transition temperature of less than or equal to about 85° C. and an electrically conductive particle; and
an electroactive material comprising silicon disposed on the primer surface coating, wherein the primer surface coating and the electroactive material remain intact on the surface of the current collector after at least one cycle of lithiation and delithiation in the electrode.

2. The electrode of claim 1, wherein the polymer is selected from the group consisting of: polyvinyl alcohol (PVA), polyvinyl acetate (PVAc), poly(vinylidene fluoride) (PVDF), polyvinylpyrrolidone (PVP), ethylene/propylene/diene copolymers (EPDM), polyethylene oxide (PEO), styrene/butadiene rubbers (SBR), polysiloxane, and combinations thereof.

3. The electrode of claim 1, wherein the current collector comprises copper or a copper alloy and the primer surface coating comprises polyvinyl alcohol (PVA) and graphite flake particles.

4. The electrode of claim 1, wherein a thickness of the primer surface coating is greater than or equal to 100 nm to less than or equal to about 10 μm.

5. The electrode of claim 1, wherein the primer surface coating comprises greater than or equal to about 5% to less than or equal to about 40% by weight of the polymer and greater than or equal to about 50% to less than or equal to about 95% weight of the electrically conductive particle.

6. The electrode of claim 1, wherein the electroactive material layer comprises a compound selected from the group consisting of: silicon (Si), Si—Sn, SiSnFe, SiSnAl, SiFeCo, and combinations thereof.

7. The electrode of claim 1, wherein the electroactive material layer comprises an electroactive material at greater than or equal to about 50% by weight to less than or equal to about 98% by weight of the electroactive material layer, wherein the electroactive material is present on the current collector at a loading density of greater than or equal to about 5 mg/cm² to less than or equal to about 50 mg/cm².

8. The electrode of claim 1, wherein the electroactive material layer comprises an electroactive material comprising silicon having a loading density of greater than or equal to about 0.25 mg/cm² to less than or equal to about 25 mg/cm².

9. A lithium ion electrochemical cell comprising:
a negative electrode comprising:
a current collector comprising a metal selected from the group consisting of: copper, copper alloys, stainless steel, and combinations thereof;
a primer surface coating formed on a surface of the current collector comprising a polymer having a glass transition temperature of less than or equal to about 85° C. and an electrically conductive particle; and
an electroactive material layer comprising silicon disposed on the primer surface coating;
a positive electrode comprising a positive lithium-based electroactive material;
a separator; and
an electrolyte; wherein the primer surface coating and the electroactive material remain intact on the surface of the current collector, so that the negative electrode has a capacity loss of less than or equal to about 25% after 25 cycles of lithiation and delithiation.

10. The lithium ion electrochemical cell of claim 9, wherein the polymer is selected from the group consisting of: polyvinyl alcohol (PVA), polyvinyl acetate (PVAc), poly(vinylidene fluoride) (PVDF), polyvinylpyrrolidone (PVP), ethylene/propylene/diene copolymers (EPDM), polyethylene oxide (PEO), styrene/butadiene rubbers (SBR), polysiloxane, and combinations thereof.

11. The lithium ion electrochemical cell of claim 9, wherein the current collector comprises copper or a copper alloy and the primer surface coating comprises polyvinyl alcohol (PVA) and graphite flake particles.

12. The lithium ion electrochemical cell of claim 9, wherein a thickness of the primer surface coating is greater than or equal to 100 nm to less than or equal to about 10 μm.

13. The lithium ion electrochemical cell of claim 9, wherein the primer surface coating comprises greater than or equal to about 5% to less than or equal to about 40% by weight of the polymer and greater than or equal to about 50% to less than or equal to about 95% weight of the electrically conductive particle.

14. The lithium ion electrochemical cell of claim 9, wherein the electroactive material layer comprises a compound selected from the group consisting of: silicon (Si), Si—Sn, SiSnFe, SiSnAl, SiFeCo, and combinations thereof.

15. The lithium ion electrochemical cell of claim 9, wherein the electroactive material layer comprises an electroactive material at greater than or equal to about 50% by weight to less than or equal to about 98% by weight of the electroactive material layer, wherein the electroactive material is present on the current collector at a loading density of greater than or equal to about 5 mg/cm² to less than or equal to about 50 mg/cm².

16. The lithium ion electrochemical cell of claim 9, wherein the electroactive material layer comprises an electroactive material comprising silicon having a loading density of greater than or equal to about 0.25 mg/cm² to less than or equal to about 25 mg/cm².

17. A method of making a negative electrode for an electrochemical cell, the method comprising:
applying a primer surface coating comprising a polymer having a glass transition temperature of less than or equal to about 85° C. and an electrically conductive particle onto a surface of a current collector comprising a metal selected from the group consisting of: copper, copper alloys, stainless steel, and combinations thereof; and
applying an electroactive material layer comprising silicon on the primer surface coating to form the negative electrode, wherein the primer surface coating and the electroactive material remain intact on the surface of the current collector after at least one cycle of lithium ion lithiation and delithiation in the negative electrode.

18. The method of claim 17, wherein the applying of the primer surface coating and the applying of the electroactive material layer are done by slurry casting.

19. The method of claim 17, wherein prior to applying the primer surface coating, mixing greater than or equal to about 5% to less than or equal to about 40% by weight of the polymer and greater than or equal to about 50% to less than or equal to about 95% by weight of the electrically conductive particle, wherein the polymer is selected from the group consisting of: polyvinyl alcohol (PVA), polyvinyl acetate (PVAc), poly(vinylidene fluoride) (PVDF), polyvinylpyrrolidone (PVP), ethylene/propylene/diene copolymers (EPDM), polyethylene oxide (PEO), styrene/butadiene rubbers (SBR), polysiloxane, and combinations thereof.

20. The method of claim 17, wherein prior to applying the electroactive material layer, mixing greater than or equal to about 50% by weight to less than or equal to about 97% by weight of the electroactive material, greater than or equal to about 0.5% by weight to less than or equal to about 5% by weight of the electrically conductive material, greater than or equal to about 0.5% by weight to less than or equal to about 5% by weight of a binder, and greater than or equal to about 10% by weight to less than or equal to about 80% by weight of one or more solvents together.
